(19) United States
(12) Patent Application Publication
(10) Pub. No.: US 2013/0326018 A1
(43) Pub. Date: Dec. 5, 2013

(54) Method for Providing Augmented Reality Service, Server and Computer-Readable Recording Medium

(71) Applicants: Jung Hee Ryu, Seoul (KR); Gilnam Kelvin Choi, Seoul (KR)

(72) Inventors: Jung Hee Ryu, Seoul (KR); Gilnam Kelvin Choi, Seoul (KR)

(21) Appl. No.: 13/976,251

(22) PCT Filed: May 31, 2012
(86) PCT No.: PCT/KR12/04292

§ 371 Date: Jul. 8, 2013

(51) Int. Cl. H04L 29/08

(52) U.S. Cl. CPC H04L 67/10
USPC 709/217

(57) ABSTRACT

According some aspects of the present invention, there is provided a method for providing an augmented reality service, including (a) receiving an image through a camera, (b) performing image matching operation on the input image in an image matching server, (c) determining by an API server whether the image can be implemented as augmented reality using a result of the image matching if the image is matched to a specific image among previously stored images, (d) providing by an AR content server augmented reality content for implementing an augmented reality scenario, if it is determined that the image can be implemented as augmented reality and (e) implementing the augmented reality using the augmented reality content by a terminal. Various images input through a camera may be implemented as augmented reality by receiving only the data needed to implement a corresponding image into the augmented reality from a server by applying an image matching technique before implementing the augmented reality, without storing the data required for implementing the augmented reality in a limited memory space of a terminal.

### TECHNICAL FIELD

The present invention relates to a method for providing an augmented reality service, a server and a computer-readable recording medium, and more specifically to a method for providing an augmented reality service, a server and a computer-readable recording medium, which can provide an augmented reality service that, without being restricted by a limited memory space and using an image matching technique, determines whether the content on an input image corresponds to a region to be displayed as augmented reality or a region to be played back as a moving image or the like, and output content relevant to a corresponding region.

### BACKGROUND

Augmented reality (AR) is a kind of virtual reality, which combines a real world shown in the eyes of a user and a virtual world having additional information and shows the combined world as one image. Although such augmented reality is partly similar to virtual reality, a virtual reality provides a user only with virtual spaces and objects whereas the augmented reality synthesizes virtual information on the basis of real world inputs and provides the synthesized information reinforced by additional information that is difficult to obtain only from the real world. Unlike the virtual reality based on a perfect virtual world, the augmented reality may provide a user with a more vivid sense of reality by adding virtual objects to an environment of a real world. Research and development of the augmented reality service has begun to progress in USA and Japan from the late 1990s, and recently, a variety of augmented reality services are provided due to improvements in computing capabilities of mobile devices such as a cellular phone, a personal digital assistant (PDA), an ultra mobile personal computer (UMPC) and the like, and advances in wireless network devices. For example, an object in a real environment may be photographed through a camera of a cellular phone, and attribute information related to the object may be virtually created and combined with the object of the real environment to be output on a screen.

An example of a conventional technique for providing such an augmented reality service is disclosed in Korean Patent Laid-Open Publication No. 10-2012-0003323 published on Jan. 10, 2012, entitled ‘Mobile terminal and method of displaying information using augmented reality thereof.’ Since information on an object provided in an augmented reality should be stored in a limited memory of a terminal and the augmented reality is implemented using the information to provide such a conventional augmented reality service, there is a problem in that the amount of images capable of being implemented in the augmented reality may be limited. Furthermore, there is also a problem in that it is difficult to reproduce various kinds of content only by simply determining whether a region needs to be implemented as augmented reality.

### DETAILED DESCRIPTION OF INVENTION

### Technical Problem

An object of the present invention is to solve all the problems described above.

In addition, another object of the present invention is to provide a method for providing an augmented reality service, a server and a computer-readable recording medium, which can implement various images as augmented reality by receiving data required for implementing a corresponding image as the augmented reality from a server using an image matching technique and implementing the augmented reality, without storing the data required for implementing the augmented reality in a limited memory space of a terminal.

Further, a further object of the present invention is to provide a method for providing an augmented reality service, a server and a computer-readable recording medium, which determine whether the contents on an input image correspond to a region to be displayed as augmented reality or a region to be played back as a general image or the like and output the contents relevant to a corresponding region.

### SUMMARY

The representative configurations of the present invention for achieving the aforementioned objects are as follows:

According to some aspects of the present invention, there is provided a method for providing an augmented reality service using an application programming interface (API) server, including: determining, by the API server, whether content related to an input image is decided to be displayed as augmented reality based on a matching result, the matching result being received by the API server, if an image input through a camera of a terminal is determined to be matched to a specific image among images previously stored in an image matching server as a result of performing image matching operation by the image matching server on the input image as a target; and requesting directly, by the API server, an augmented reality (AR) content server to provide augmented reality content for implementing an augmented reality scenario, or requesting, by the API server, the AR content server to provide the augmented reality content for implementing the augmented reality scenario by way of the terminal, if the content related to the input image is decided to be displayed as augmented reality.

According some other aspects of the present invention, there is provided a method for providing an augmented reality service using an AR content server, including: receiving, by the AR content server, a request for providing augmented reality content for implementing an augmented reality scenario directly from an API server, or receiving, by the AR content server, a request for providing the augmented reality content for implementing the augmented reality scenario from the API server by way of a terminal, if image matching operation is performed by an image matching server on an image as a target input through a camera of the terminal and it is determined that an input image is matched to a specific image among images previously stored in the image matching server, and if the API server determines whether content related to the input image is decided to be displayed as augmented reality based on a matching result, the matching result being received by the API server, and determines that the content related to the input image is decided to be displayed as augmented reality; and transmitting, by the AR content server, the augmented reality content to the terminal.

According to further aspects of the present invention, there is provided a method for providing an augmented reality service using a first augmented reality service providing server, including: determining, by the first augmented reality service providing server, whether content related to an input image is decided to be displayed as augmented reality based on a matching result, if the first augmented reality service providing server performs image matching operation on an image as a target input through a camera of a terminal and determines that the input image is matched to a specific image among images previously stored in the first augmented reality service providing server; and requesting directly, by the first augmented reality service providing server, an AR content server to provide augmented reality content for implementing an augmented reality scenario, or requesting, by the first augmented reality service providing server, the AR content server to provide the augmented reality content for implementing the augmented reality scenario by way of the terminal, if the first augmented reality service providing server determines that the content related to the input image is decided to be displayed as augmented reality.

According to still further aspects of the present invention, there is provided a method for providing an augmented reality service using a second augmented reality service providing server, including: determining, by the second augmented reality service providing server, whether content related to an input image is decided to be displayed as augmented reality based on a matching result, the matching result being received by the second augmented reality service providing server, if the second augmented reality service providing server determines that an image input through a camera of a terminal is matched to a specific image among images previously stored in an image matching server as a result of performing image matching operation by the image matching server on the input image as a target; and transmitting, by the second augmented reality service providing server, augmented reality content for implementing an augmented reality scenario to the terminal, the augmented reality content being extracted by the second augmented reality service providing server, if the second augmented reality service providing server determines that the content related to the input image is decided to be displayed as augmented reality.

According to still further aspects of the present invention, there is provided a method for providing an augmented reality service using a third augmented reality service providing server, including: receiving, by the third augmented reality service providing server, a request for providing augmented reality content for implementing an augmented reality scenario directly from an API server, or receiving, by the third augmented reality service providing server, a request for providing the augmented reality content for implementing the augmented reality scenario from the API server by way of a terminal, if the third augmented reality service providing server performs image matching operation on an image as a target input through a camera of a terminal and determines that an input image is matched to a specific image among images previously stored in the third augmented reality service providing server, and if the API server determines that content related to the input image is decided to be displayed as augmented reality based on a matching result, the matching result being received by the API server; and transmitting, by the third augmented reality service providing server, the augmented reality content to the terminal.

According to still further aspects of the present invention, there is provided a method for providing an augmented reality service using a fourth augmented reality service providing server, including: determining, by the fourth augmented reality service providing server, whether content related to an input image is decided to be displayed as augmented reality based on a matching result, if the fourth augmented reality service providing server performs image matching operation on an image as a target input through a camera of a terminal and determines that the input image is matched to a specific image among images previously stored in the fourth augmented reality service providing server; and transmitting, by the fourth augmented reality service providing server, augmented reality content for implementing an augmented reality scenario to the terminal, the augmented reality content being extracted by the fourth augmented reality service providing server, if the content related to the input image is decided to be displayed as augmented reality.

According to still further aspects of the present invention, there is provided an API server for providing an augmented reality service, including: an AR region determination unit for determining whether content related to an input image is decided to be displayed as augmented reality based on a matching result, the matching result being received by the AR region determination unit, if an image input through a camera of a terminal is determined to be matched to a specific image among images previously stored in an image matching server as a result of performing image matching operation by the image matching server on the input image as a target; and a content request unit for requesting directly an AR content server to provide augmented reality content for implementing an augmented reality scenario, or requesting the AR content server to provide the augmented reality content for implementing the augmented reality scenario by way of the terminal, if the content related to the input image is decided to be displayed as augmented reality.

According to still further aspects of the present invention, there is provided an AR content server for providing an augmented reality service, including: a content request reception unit for receiving a request to provide augmented reality content for implementing an augmented reality scenario directly from an API server, or receiving a request to provide the augmented reality content for implementing the augmented reality scenario from the API server by way of a terminal, if image matching operation is performed by an image matching server on an image as a target input through a camera of the terminal and it is determined that an input image is matched to a specific image among images previously stored in the image matching server, and if the API server determines whether content related to the input image is decided to be displayed as augmented reality based on a matching result, the matching result being received by the API server, and determines that the content related to the input image is decided to be displayed as augmented reality; and a content providing unit for transmitting the augmented reality content to the terminal.

According to still further aspects of the present invention, there is provided a first augmented reality service providing server for providing an augmented reality service, including: an AR region determination unit for determining whether content related to an input image is decided to be displayed as augmented reality based on a matching result, if image matching operation is performed on an image as a target input through a camera of a terminal and it is determined that the input image is matched to a specific image among previously stored images; and a content request unit for requesting directly an AR content server to provide augmented reality content for implementing an augmented reality scenario, or requesting the AR content server to provide the augmented reality content for implementing the augmented reality scenario by way of the terminal, if it is determined that the content related to the input image is decided to be displayed as augmented reality.

According to still further aspects of the present invention, there is provided a second augmented reality service providing server for providing an augmented reality service, including: an AR region determination unit for determining whether content related to an input image is decided to be displayed as augmented reality based on a matching result, the matching result being received by the AR region determination unit, if it is determined that an image input through a camera of a terminal is matched to a specific image among images previously stored in an image matching server as a result of performing image matching operation by the image matching server on the input image as a target; and a content providing unit for transmitting augmented reality content for implementing an augmented reality scenario to the terminal, the augmented reality content being extracted by the content providing unit, if it is determined that the content related to the input image is decided to be displayed as augmented reality.

According to still further aspects of the present invention, there is provided a third augmented reality service providing server for providing an augmented reality service, including: a content request reception unit for receiving a request to provide augmented reality content for implementing an augmented reality scenario directly from an API server, or receiving a request for providing the augmented reality content for implementing the augmented reality scenario from the API server by way of a terminal, if image matching operation is performed on an image as a target input through a camera of the terminal and it is determined that the input image is matched to a specific image among previously stored images, and if the API server determines that content related to the input image is decided to be displayed as augmented reality based on a matching result, the matching result being received by the API server; and a content providing unit for transmitting the augmented reality content to the terminal.

According to still further aspects of the present invention, there is provided a fourth augmented reality service providing server for providing an augmented reality service, including: an AR region determination unit for determining whether content related to an input image is decided to be displayed as augmented reality based on a matching result, if image matching operation is performed on an image as a target input through a camera of a terminal and it is determined that the input image is matched to a specific image among previously stored images; and a content providing unit for transmitting augmented reality content for implementing an augmented reality scenario to the terminal, the augmented reality content being extracted by the content providing unit, if the content related to the input image is decided to be displayed as augmented reality.

### Advantageous Effects of Invention

According to some embodiments of the present invention, it is possible to implement various images as augmented reality by receiving data required for implementing a corresponding image as the augmented reality from a server using an image matching technique and implementing the augmented reality, without storing the data required for implementing the augmented reality in a limited memory space of a terminal is provided.

Further, according to some embodiments of the present, it is possible to determine whether the content on an input image correspond to a region to be displayed as augmented reality or a region to be played back as a general image or the like and output the content relevant to a corresponding region.

### BRIEF DESCRIPTION OF DRAWINGS

FIG. 1 is a view schematically showing the configuration of an augmented reality service providing system according to an embodiment of the present invention.

FIG. 2 is a view illustrating a data transmission and reception procedure for providing an augmented reality service in an augmented reality service providing system according to an embodiment of the present invention.

FIG. 3 is a view illustrating a data transmission and reception procedure for providing an augmented reality service in an augmented reality service providing system according to an embodiment of the present invention.

FIG. 4 is a view illustrating a data transmission and reception procedure for providing an augmented reality service in an augmented reality service providing system according to an embodiment of the present invention.

FIG. 5 is a view illustrating a data transmission and reception procedure for providing an augmented reality service in an augmented reality service providing system according to an embodiment of the present invention.

FIG. 6 is a view illustrating a data transmission and reception procedure for providing an augmented reality service in an augmented reality service providing system according to an embodiment of the present invention.

### EMBODIMENTS

In the following detailed description of the present invention, references are made to the accompanying drawings that show, by way of illustration, specific embodiments in which the present invention may be implemented. These embodiments are described in sufficient detail to enable those skilled in the art to implement the present invention. It should be understood that various embodiments of the present invention, although different, are not necessarily mutually exclusive. For example, specific feature, structure, and characteristic described herein, in connection with one embodiment, may be implemented within other embodiments without departing from the spirit and scope of the present invention. In addition, it should be understood that the location or arrangement of individual elements within each disclosed embodiment may be modified without departing from the spirit and scope of the present invention. The following detailed description is, therefore, not to be taken in a limiting sense, and the scope of the present invention is defined only by the appended claims, appropriately interpreted, along with the full range equivalent to what the claims claim. In the drawings, like reference numbers refer to the same or similar function through many ways.

Hereinafter, preferred embodiments of the present invention will be described in detail with reference to the accompanying drawings in order to easily implement the present invention by those skilled in the art.

First Embodiment

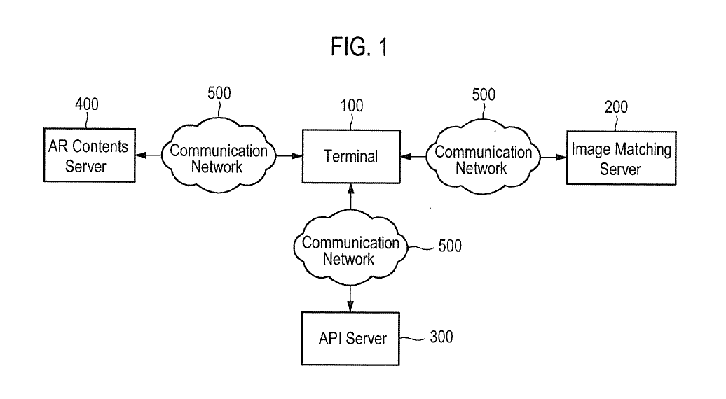

FIG. 1 is a view schematically showing a configuration of an augmented reality service providing system according to an embodiment of the present invention.

Referring to FIG. 1, the augmented reality service providing system may include a terminal 100, an image matching server 200, an application programming interface (API) server 300 and an augmented reality (AR) content server 400.

The terminal 100 is a digital device. Any portable digital device provided with a memory means and equipped with a microprocessor to have operation capability, such as a personal computer (e.g., a tablet computer, a laptop computer, etc.), a personal digital assistant (PDA), a web pad, a cellular phone, may be adopted as the terminal 100 according to the present invention.

The terminal 100 may include a camera and a natural feature tracking (NFT) engine therein. The camera is configured of a conventional, general image pickup device, and for example, it may be a digital camera which uses a charge coupled device (CCD) to create digital image signals. In addition, the NFT engine may perform a function of implementing augmented reality on an image input through the camera using provided AR content.

The image matching server 200 performs a function of comparing information on the image input through the camera with information on each of a plurality of images stored in a database and then outputting a result of the image matching. That is, whether the image input through the camera is identical (or similar) to at least one of the previously stored images is detected, and a signal indicating that the compared images are matched if the images are determined to be identical to each other or a signal indicating that the compared images are mismatched if the images are determined to be different from each other, can be output as a result of the image matching. Whether the images are identical or similar to each other may be determined by comparing feature information extracted from the respective images with each other. If it is determined that the similarity between the images equals or exceeds a threshold similarity as a result of the comparison of feature information, the images may be determined to be identical or similar to each other. In addition, each of the plurality of images stored in the database may have an identification symbol, and the image matching server 200 may output the identification symbol of a matched image among the plurality of images as a signal indicating that the image is matched. As an example of the identification symbol, if the input image is an image of a specific person, the name or the like of the corresponding person may be used as the identification symbol. Alternatively, the image matching server 200 may output an index number of a matched image, and the index number may be a number matching to a memory storage space in the API server 300.

The inventors of the present invention have already filed a patent application relating to a method and apparatus for recognizing an input image by matching the input image to a previously stored image in Korean Patent Application No. 10-2011-0105547, entitled ‘Face Recognition Method, Apparatus, and Computer-readable Recording Medium for executing the method,’ which may be incorporated with the present invention.

The API server 300 performs a function of determining whether content related to the image matching to the identification symbol or index number is decided to be displayed as augmented reality based on the identification symbol or index number, the identification symbol or index number being decided by the image matching server 200. In more detail, identification symbols or index numbers of images expected to be displayed as augmented reality are previously stored in the memory of the API server 300, and it is determined whether the content related to the image input through the camera is expected to be displayed as augmented reality by comparing the identification symbol or index number decided by the image matching server 200 with the identification symbols or index numbers previously stored in the API server 300. In addition, when the content related to the image are expected to be displayed as augmented reality, the API server 300 performs a function of outputting a signal for calling the content required to implement an augmented reality scenario expected for each image. In addition, the API server 300 may determine whether the content on the input image correspond to a region to be displayed as augmented reality or a region to be played back as a general image and output content relevant to a corresponding region.

If the AR content server 400 is requested to provide augmented reality content for implementing the augmented reality scenario directly from the API server 300 or requested to provide the augmented reality content for implementing the augmented reality scenario by way of the terminal, the AR content server 400 performs a function of providing previously stored augmented reality content. In more detail, the augmented reality content, which is data for executing the augmented reality scenario, may include an AR scenario data, a feature value data created through a trackable image data or a corresponding data, and a 3D object data, and may be created in XML. The feature value data created through the trackable image data or the corresponding data may be an image data or feature information of the image data provided to the terminal 100 so that the terminal 100 may track (i.e., perform NFT on) a target determined to be matched by the image matching server 200, and the feature value data created through the trackable image data or the corresponding data may be a data separate from the feature information used for image matching by the image matching server 200. Meanwhile, the 3D object data is a data used for image matching of a 3D image on the surface of an object according to the augmented reality scenario.

The terminal 100 may transmit and receive data through the image matching server 200, the API server 300, the AR content server 400 and a communication network 500. Here, the communication network 500 may be configured in a wireless communication scheme and include a variety of communication networks such as a mobile communication network, a satellite communication network and the like. In more detail, the communication network mentioned in the present invention should be understood as a concept including various kinds of well-known communication networks such as wireless LAN (WLAN), code division multiple access (CDMA), wideband code division multiple access (WCDMA) and global system for mobile communications (GSM) networks.

Hereinafter, a data transmission and reception procedure for providing an augmented reality service in an augmented reality service providing system will be described. Although not shown in the figure, the API server 300 may include an AR region determination unit and a content request unit, and the AR content server 400 may include a content request reception unit and a content providing unit, wherein each of the units may perform the operation for providing the augmented reality service described below.

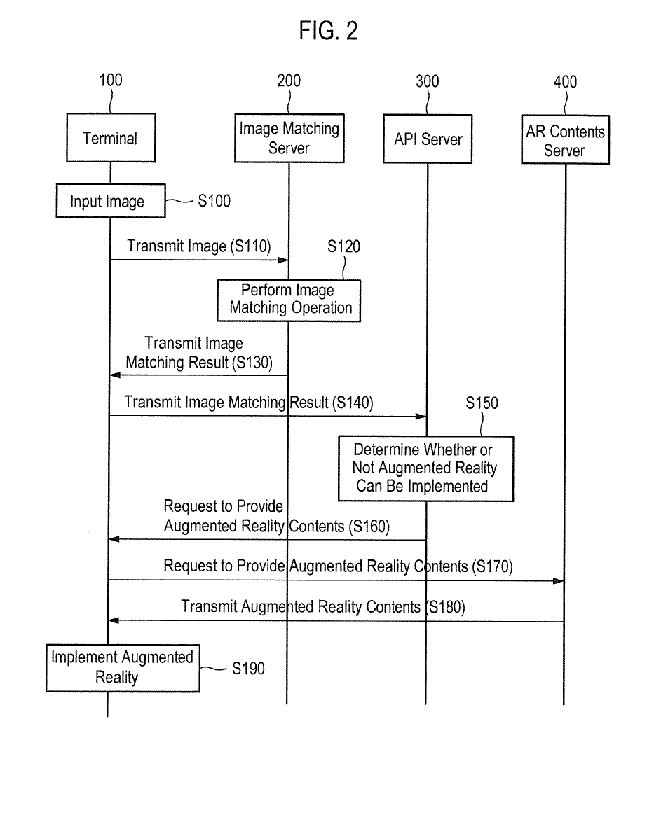

FIG. 2 is a view illustrating a data transmission and reception procedure for providing an augmented reality service in an augmented reality service providing system according to an embodiment of the present invention. Referring to FIG. 2, the terminal 100 receives an image through a camera formed therein (S100). The input image may be a single image photographed through the camera or an image input in a preview state. In the case that the input image is in a preview state, if a relative position of an object moves on the image as the terminal moves, the 3D image implemented on the image may also move together. This is possible since the feature data created through a corresponding trackable image data or a corresponding data is provided (e.g., in the form of download) to the terminal 100 so that the terminal 100 may track (i.e., perform NFT on) a target determined to be matched by the image matching server 200 as described above.

The terminal 100 transmits the image to the image matching server 200 (S110), and the image matching server 200 performs image matching operation on the input image (S120). A variety of conventional, public methods described above may be applied to the image matching operation. If the image matching is completed by the image matching server 200 and it is determined that the feature information of the input image has high similarity with the feature information of a specific image among the images previously stored in the image matching server 200, the image matching server 200 transmits a result of the image matching to the terminal 100 (S130).

The terminal 100 transmits the matching result transmitted from the image matching server 200 to the API server 300 (S140), and the AR region determination unit of the API server 300 determines whether the content related to the image input through the camera is decided to be displayed as augmented reality using the matching result (S150). The information output as the matching result may be an identification symbol or index number as described above. The API server 300 determines whether the content related to the image input through the camera is decided to be displayed as augmented reality by comparing the identification symbol or index number decided by the image matching server 200 with the identification symbols or index numbers previously stored in the API server 300. In addition, the API server 300 may determine whether the content on the input image correspond to a region to be displayed as augmented reality or a region to be played back as a general image and output content relevant to a corresponding region. If the content related to the input image is decided to be displayed as augmented reality, the content request unit of the API server 300 transmits a signal for calling the content required to implement an augmented reality scenario expected for the corresponding image to the terminal 100 (S160).

The terminal 100 receiving the signal for calling the content required to implement the augmented reality scenario from the API server 300 requests the AR content server 400 to provide the augmented reality content required to implement the augmented reality scenario (S170). Of course, the present invention is not limited thereto, but the API server 300 may directly request the AR content server 400 to provide the terminal 100 with the content required to implement the augmented reality scenario without going through the terminal 100. If the content request reception unit of the AR content server 400 receives the signal requesting to provide the augmented reality content from the terminal 100, the content providing unit transmits previously stored augmented reality content to the terminal 100 (S180). The terminal 100 receiving the augmented reality content from the AR content server 400 implements the augmented reality by driving the NFT engine using the augmented reality content (S190).

Although the image matching server 200, the API server 300 and the AR content server 400 may be configured as separated servers, the present invention is not limited thereto, but parts of the respective server may be provided in an integrated form. A procedure of transmitting and receiving data between the terminal 100 and the respective servers will be described below in further detail in the case that the servers are separated or parts of the respective servers are integrated.

In addition, when the respective servers are provided in an integrated form, at least some of the image matching server 200, the API server 300 and the AR content server 400 may be program modules communicating with the terminal 100. Such program modules may be included in an integrated server in the form of an operating system, an application program module or other program modules, and physically, they can be stored in a variety of well-known memory devices. In addition, these program modules may be stored in a remote memory device capable of communicating with the integrated server.

Although such program modules include routines, subroutines, programs, objects, components, data structures and the like, which execute specific abstract data types or perform specific tasks which will be described later according to the present invention, the program modules are not limited thereto.

Second Embodiment

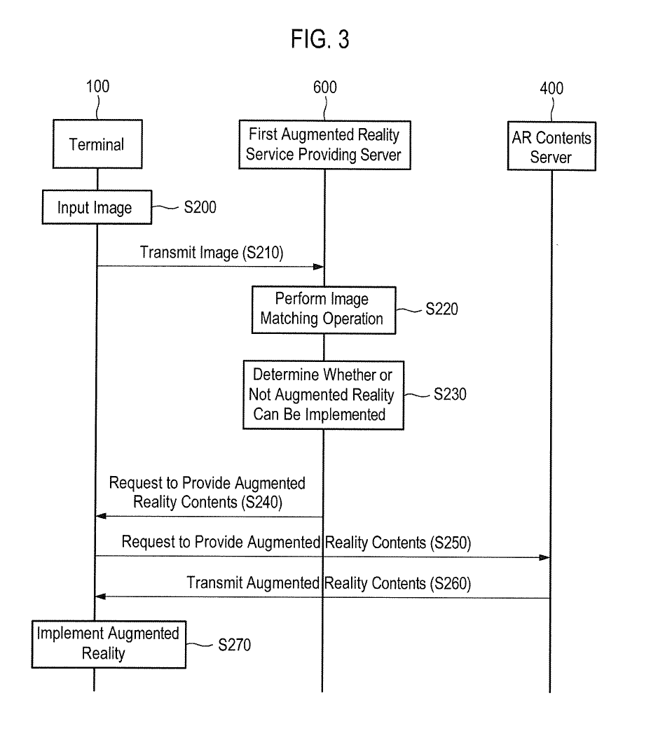

FIG. 3 is a view illustrating a data transmission and reception procedure for providing an augmented reality service in an augmented reality service providing system according to an embodiment of the present invention.

Referring to FIG. 3, the augmented reality service providing system may include a terminal 100, a first augmented reality service providing server 600 and an AR content server 400. The terminal 100 and the AR content server 400 are the same as those described with reference to FIG. 1, and the first augmented reality service providing server 600 is a server into which the image matching server 200 and the API server 300 described with reference to FIG. 1 are integrated.

Although not shown in the figure, the first augmented reality service providing server 600 may include an AR region determination unit and a content request unit in addition to an image matching unit, and each of the units may perform the operation for providing an augmented reality service described below.

The data transmission and reception procedure for providing an augmented reality service in the augmented reality service providing system illustrated in FIG. 3 will be described as follows.

First, the terminal 100 receives an image through a camera formed therein (S200). The image may be a single image photographed through the camera or an image input in a preview state. The terminal 100 transmits the image to the first augmented reality service providing server 600 (S210), and the first augmented reality service providing server 600 performs image matching operation on the input image (S220). A variety of conventional, well-known methods described above may be applied to the image matching operation. If it is determined that the feature information of the input image has highly similarity with the feature information of an image previously stored in the first augmented reality service providing server 600 as a result of the image matching completed by the first augmented reality service providing server 600, the AR region determination unit of the first augmented reality service providing server 600 determines whether the content related to the image input through the camera is decided to be displayed as augmented reality using the result of the image matching (S230). The matching result may be an identification symbol or index number as described above. The first augmented reality service providing server 600 determines whether the content related to the image input through the camera is decided to be displayed as augmented reality by comparing the decided identification symbol or index number with identification symbols or index numbers previously stored in the first augmented reality service providing server 600. In addition, the first augmented reality service providing server 600 may determine whether the content on the input image correspond to a region to be displayed as augmented reality or a region to be played back as a general image and output content relevant to a corresponding region. If the content related to the image is to be displayed as augmented reality, the content request unit of the first augmented reality service providing server 600 transmits a signal for calling the content required to implement an augmented reality scenario expected for the corresponding image to the terminal 100 (S240).

The terminal 100, which receives the signal for calling the content required to implement an augmented reality scenario from the first augmented reality service providing server 600, requests the AR content server 400 to provide the augmented reality content required to implement the augmented reality scenario (S250). Of course, the present invention is not limited thereto, but the first augmented reality service providing server 600 may directly request the AR content server 400 to provide the terminal 100 with the content required to implement the augmented reality without going via the terminal 100. If the AR content server 400 receives the signal requesting to provide the augmented reality content, the AR content server 400 transmits previously stored augmented reality content to the terminal 100 (S260).

The terminal 100 receiving the augmented reality content from the AR content server 400 implements the augmented reality by driving the NFT engine using the augmented reality content (S270).

Third Embodiment

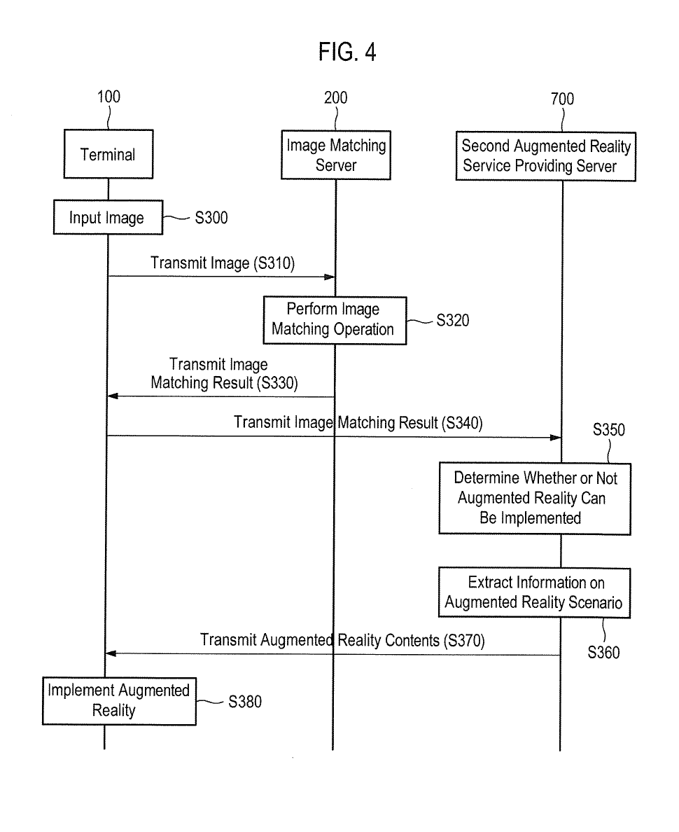

FIG. 4 is a view illustrating a data transmission and reception procedure for providing an augmented reality service in an augmented reality service providing system according to an embodiment of the present invention.

Referring to FIG. 4, the augmented reality service providing system may include a terminal 100, an image matching server 200 and a second augmented reality service providing server 700. The terminal 100 and the image matching server 200 are the same as those described with reference to FIG. 1, and the second augmented reality service providing server 700 is a server into which the API server 300 and the AR content server 400 described with reference to FIG. 1 are integrated.

Although not shown in the figure, the second augmented reality service providing server 700 may include an AR region determination unit and a content providing unit, and each of the units may perform the operation for providing an augmented reality service described below.

The data transmission and reception procedure for providing an augmented reality service in the augmented reality service providing system shown in FIG. 4 will be described as follows.

First, the terminal 100 receives an image through a camera formed therein (S300). The image may be a single image photographed through the camera or an image input in a preview state. The terminal 100 transmits the image to the image matching server 200 (S310), and the image matching server 200 performs image matching operation on the input image (S320). A variety of conventional, public methods described above may be applied to the image matching operation. When the image matching is completed by the image matching server 200 and it is determined that the feature information of the input image has high similarity with the feature information of a specific image among the images previously stored in the image matching server 200, the image matching server 200 transmits a matching result to the terminal 100 (S330).

The terminal 100 transmits the matching result transmitted from the image matching server 200 to the second augmented reality service providing server 700 (S340), and the AR region determination unit of the second augmented reality service providing server 700 determines whether the content related to the image input through the camera is to be displayed as augmented reality by comparing an identification symbol or index number decided by the image matching server 200 with previously stored identification symbols or index numbers (S350). In addition, the second augmented reality service providing server may determine whether the content on the input image correspond to a region to be displayed as augmented reality or a region to be played back as a general image and output content relevant to a corresponding region. If the content related to the input image is to be displayed as augmented reality, the second augmented reality service providing server 700 extracts the content required to implement an augmented reality scenario expected for the corresponding image (S360). Then, the content providing unit of the second augmented reality service providing server 700 transmits previously stored augmented reality content needed to implement the augmented reality scenario to the terminal 100 (S370).

The terminal 100 receiving the augmented reality content from the second augmented reality service providing server 700 implements the augmented reality by driving the NFT engine using the augmented reality content (S380).

Fourth Embodiment

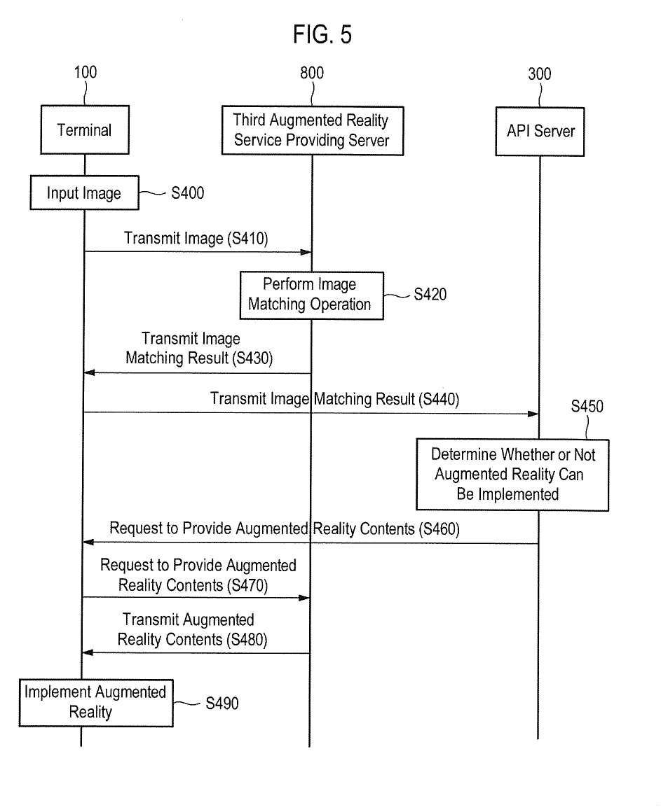

FIG. 5 is a view illustrating a data transmission and reception procedure for providing an augmented reality service in an augmented reality service providing system according to an embodiment of the present invention.

Referring to FIG. 5, the augmented reality service providing system may include a terminal 100, a third augmented reality service providing server 800 and an API server 300. The terminal 100 and the API server 300 are the same as those described with reference to FIG. 1, and the third augmented reality service providing server 800 is a server into which the image matching server 200 and the AR content server 400 described with reference to FIG. 1 are integrated.

Although not shown in the figure, the third augmented reality service providing server 800 may include a content request reception unit and a content providing unit in addition to an image matching unit, and each of the units may perform the operation for providing an augmented reality service described below.

The data transmission and reception procedure for providing an augmented reality service in the augmented reality service providing system shown in FIG. 5 will be described as follows.

First, the terminal 100 receives an image through a camera formed therein (S400). The image may be a single image photographed through the camera or an image input in a preview state. The terminal 100 transmits the image to the third augmented reality service providing server 800 (S410), and the image matching unit of the third augmented reality service providing server 800 performs image matching operation on the input image (S420). A variety of conventional, public methods described above may be applied to the image matching operation. If the image matching is completed by the third augmented reality service providing server 800 and it is determined that the feature information of the input image has high similarity with the feature information of a specific image among the images previously stored in the third augmented reality service providing server 800, the third augmented reality service providing server 800 transmits a result of the image matching to the terminal 100 (S430).

The terminal 100 transmits the matching result transmitted from the third augmented reality service providing server 800 to the API server 300 (S440), and the API server 300 determines whether the content related to the image input through the camera is decided to be displayed as augmented reality using the matching result (S450). The matching result may be an identification symbol or index number as described above. The API server 300 determines whether the content related to the image input through the camera is to be displayed as augmented reality by comparing the identification symbol or index number decided by the third augmented reality service providing server 800 with identification symbols or index numbers previously stored in the API server 300. If the content related to the input image is decided to be displayed as augmented reality, the API server 300 transmits a signal for calling the content required to implement an augmented reality scenario expected for the corresponding image to the terminal 100 (S460).

The terminal 100 receiving the signal for calling the content required to implement an augmented reality scenario from the API server 300 requests the content request reception unit of the third augmented reality service providing server 800 to provide the augmented reality content required to implement the augmented reality scenario (S470). Of course, the present invention is not limited thereto, but the API server 300 may directly request the content request reception unit of the third augmented reality service providing server 800 to provide the terminal 100 with the content required to implement the augmented reality scenario without going via the terminal 100. If the third augmented reality service providing server 800 receives the signal requesting to provide the augmented reality content from the terminal 100, the content providing unit transmits previously stored augmented reality content to the terminal 100 (S480).

The terminal 100 receiving the augmented reality content from the third augmented reality service providing server 800 implements the augmented reality by driving the NFT engine using the augmented reality content (S490).

Fifth Embodiment

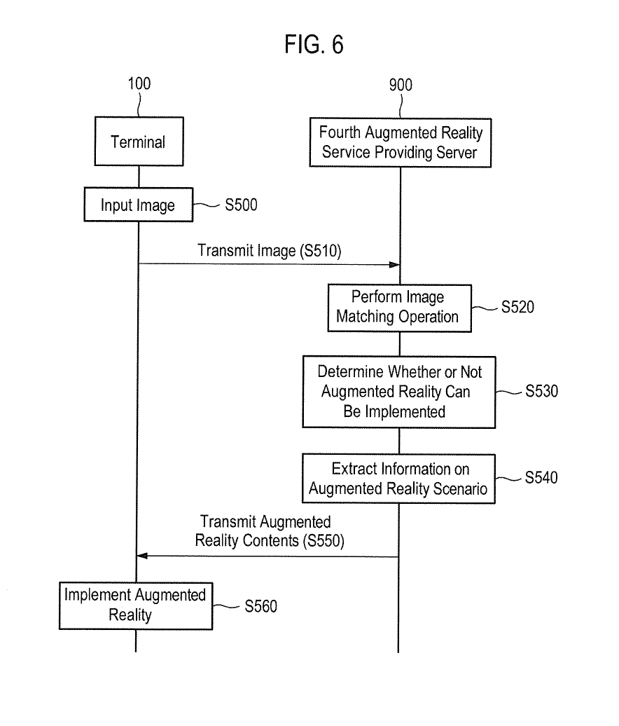

FIG. 6 is a view illustrating a data transmission and reception procedure for providing an augmented reality service in an augmented reality service providing system according to an embodiment of the present invention.

Referring to FIG. 6, the augmented reality service providing system may include a terminal 100 and a fourth augmented reality service providing server 900.

The terminal 100 is the same as that described with reference to FIG. 1, and the fourth augmented reality service providing server 900 is a server into which the image matching server 200, the API server 300 and the AR content server 400 described with reference to FIG. 1 are physically integrated.

Although not shown in the figure, the fourth augmented reality service providing server 900 may include an AR region determination unit, a content request unit, a content request reception unit, a content providing unit and the like in addition to an image matching unit, and each of the units may perform the operation for providing an augmented reality service described below. The data transmission and reception procedure for providing an augmented reality service in the augmented reality service providing system shown in FIG. 6 will be described as follows.

First, the terminal 100 receives an image through a camera formed therein (S500). The image may be a single image photographed through the camera or an image input in a preview state. The terminal 100 transmits the image to the fourth augmented reality service providing server 900 (S510), and the fourth augmented reality service providing server 900 performs image matching operation on the input image (S520). A variety of conventional, public methods described above may be applied to the image matching operation. If it is determined that the feature information of the input image has high similarity with the feature information of a specific image among the images previously stored in the fourth augmented reality service providing server 900 as a result of the image matching completed by the fourth augmented reality service providing server 900, the AR region determination unit of the fourth augmented reality service providing server 900 determines whether the content related to the image input through the camera is decided to be displayed as augmented reality using a result of the image matching (S530). In addition, the fourth augmented reality service providing server may determine whether the content on the input image correspond to a region to be displayed as augmented reality or a region to be played back as a general image and output content relevant to a corresponding region. If the content related to the input image is decided to be displayed as augmented reality, the fourth augmented reality service providing server 900 extracts the content required to implement an augmented reality scenario expected for the corresponding image (S540). Then, the content providing unit of the fourth augmented reality service providing server 900 transmits previously stored augmented reality content needed to implement the augmented reality scenario to the terminal 100 (S550).

The terminal 100, which receives the augmented reality content from the fourth augmented reality service providing server 900, implements the augmented reality by driving the NFT engine using the augmented reality content (S560).

Although not shown in the figure, the image matching server may be configured to be included in the terminal 100. That is, it is possible to consider an embodiment in which both the matching and the tracking are performed in one terminal without using a server.

The embodiments according to the present invention described above can be implemented in the form of program commands that can be executed through various computer components and recorded in a computer-readable recording medium. The computer-readable recording medium may include a program command, a data file, a data structure and the like solely or in a combined manner. The program command recorded in the computer-readable recording medium may be a program command specially designed and configured for the present invention or a program command known to be used by those skilled in the art of the computer software field. The computer-readable recording medium includes, for example, a magnetic medium, such as a hard disk, a floppy disk and a magnetic tape, an optical recording medium, such as a CD-ROM and a DVD, a magneto-optical medium, such as a floptical disk, and a hardware device specially configured to store and execute program commands, such as a ROM, a RAM, a flash memory and the like. The program command includes, for example, a high-level language code that can be executed by a computer using an interpreter or the like, as well as a machine code generated by a compiler. The hardware devices can be configured to operate using one or more software modules in order to perform the processing according to the present invention, and vice versa.

In the foregoing discussion, although the present invention has been described in connection with the specific matters, such as the specific components, the exemplary embodiments, and the drawings, they are provided only for assisting in the entire understanding of the present invention, and the present invention is not limited to the embodiments. It will be apparent that those skilled in the art can make various modifications and changes thereto from these descriptions.

Therefore, the spirit of the present invention should not be limited to the aforementioned embodiments, and the appended claims and what are modified equally or equivalently thereto will be considered to fall within the scopes of the present invention.

1. A method for providing an augmented reality service using an application programming interface (API) server, comprising:
determining, by the API server, whether content related to an input image is decided to be displayed as augmented reality based on a matching result, the matching result being received by the API server, if an image input through a camera of a terminal is determined to be matched to a specific image among previously stored images as a result of performing image matching operation on the input image as a target; and
requesting directly, by the API server, an augmented reality (AR) content server to provide augmented reality content for implementing an augmented reality scenario, or requesting, by the API server, the AR content server to provide the augmented reality content for implementing the augmented reality scenario by way of the terminal, if the content related to the input image is decided to be displayed as augmented reality.

2-5. (canceled)

6. A method for providing an augmented reality service using a fourth augmented reality service providing server, comprising:
determining, by the fourth augmented reality service providing server, whether content related to an input image is decided to be displayed as augmented reality based on a matching result, if the fourth augmented reality service providing server performs image matching operation on an image as a target input through a camera of a terminal and determines that the input image is matched to a specific image among images previously stored in the fourth augmented reality service providing server; and
transmitting, by the fourth augmented reality service providing server, augmented reality content for implementing an augmented reality scenario to the terminal, the augmented reality content being extracted by the fourth augmented reality service providing server, if the content related to the input image is decided to be displayed as augmented reality.

7. The method of claim 6, wherein the image is a single image photographed through the camera or an image input in a preview state.

8. The method of claim 7, wherein if the image is input in the preview state, and if a relative position of an object moves on the image as the terminal moves, a 3D image implemented on the image also moves.

9. The method of claim 6, wherein if it is determined that feature information of the input image has high similarity with feature information of a specific image among the previously stored images as a result of the image matching operation, an identification symbol assigned to the specific image is provided as a result of the image matching.

10. The method of claim 9, wherein the identification symbol is an index number.

11. The method of claim 6, wherein determining whether the content related to the input image is decided to be displayed as augmented reality includes, determining whether the content related to the input image is determined to be displayed as the augmented reality by previously storing an identification symbol of an image that can be displayed as augmented reality and comparing an identification symbol provided as a result of the image matching operation with the previously stored identification symbol.

12. The method of claim 6, wherein the augmented reality content include an AR scenario data, a feature value data created through a trackable image data or a corresponding data, and a 3D object data, the feature value data created through the trackable image data or the corresponding data being an image data or feature information of the image data for tracking, by the terminal, a target determined to be matched by the image matching operation.

13. The method of claim 1, wherein the API server determines whether the content on the input image correspond to a region to be displayed as augmented reality or a region to be played back as a general image and outputs content relevant to a corresponding region.

14. The method of claim 3, wherein the first augmented reality service providing server determines whether the content on the input image correspond to a region to be displayed as augmented reality or a region to be played back as a general image and outputs content relevant to a corresponding region.

15. The method of claim 4, wherein the second augmented reality service providing server determines whether the content on the input image correspond to a region to be displayed as augmented reality or a region to be played back as a general image and outputs content relevant to a corresponding region.

16-21. (canceled)

22. A fourth augmented reality service providing server for providing an augmented reality service, comprising:
an AR region determination unit for determining whether content related to an input image is decide to be displayed as augmented reality based on a matching result, if image matching operation is performed on an image as a target input through a camera of a terminal and it is determined that the input image is matched to a specific image among previously stored images; and
a content providing unit for transmitting augmented reality content for implementing an augmented reality scenario to the terminal, the augmented reality content being extracted by the content providing unit, if the content related to the input image is decided to be displayed as augmented reality.

23. The server of claim 22, wherein the image is a single image photographed through the camera or an image input in a preview state.

24. The server of claim 23, wherein if the image is input in the preview state, and if a relative position of an object moves on the image as the terminal moves, a 3D image implemented on the image also moves.

25. The server of claim 22, wherein if it is determined that feature information of the input image has high similarity with feature information of a specific image among the previously stored images as a result of the image matching operation, an identification symbol assigned to the specific image is provided as a result of the image matching.

26. The server of claim 25, wherein the identification symbol is an index number.

27. The server of claim 22, wherein the augmented reality content include an AR scenario data, a feature value data created through a trackable image data or a corresponding data, and a 3D object data, the feature value data created through the trackable image data or the corresponding data being an image data or feature information of the image data for tracking, by the terminal, a target determined to be matched by the image matching operation.

28-30. (canceled)

31. The server of claim 22, wherein the fourth augmented reality service providing server determines whether the content on the input image correspond to a region to be displayed as augmented reality or a region to be played back as a general image and outputs content relevant to a corresponding region.

32. The method of claim 1, wherein the image matching operation is performed in the terminal or a separate image matching server.

33. (canceled)

34. A computer-readable recording medium for recording a computer program for executing a method of any one of claim 1.

35. A computer-readable recording medium for recording a computer program for executing a method of any one of claim 1.
